(19) United States
(12) Patent Application Publication
(10) Pub. No.: US 2023/0003183 A1
(43) Pub. Date: Jan. 5, 2023

(54) TAPPET ROLLER ASSEMBLY

(71) Applicants: Mustafa Utku UNAL, Sodertalje (SE); Cummins Inc., Columbus, IN (US)

(72) Inventors: Romaine O. Edwards, Greenwood, IN (US); Mustafa Utku Unal, Sodertalje (SE); Aleksandr E. Lesin, Columbus, IN (US); Chin-Pei Wang, Greenwood, IN (US); Neil Jeffries, Indianapolis, IN (US); Jason R. Garcia, Franklin, IN (US)

(21) Appl. No.: 17/784,435

(22) PCT Filed: Dec. 19, 2019
(86) PCT No.: PCT/US2019/067501

§ 371 Date: Jun. 10, 2022

(51) Int. Cl. F02M 59/10; F16H 53/06; F16H 57/04

(52) U.S. Cl. CPC F02M 59/102; F16H 53/06; F16H 57/0467; F16H 57/042

(57) ABSTRACT

A tappet roller assembly in which a roller shoe has a roller bore shaped to receive and retain a roller. The roller is sized and configured to rotate within the roller bore. The roller shoe may have a lubricating passage extending from a peripheral surface of the roller shoe to the roller bore to lubricate the roller.

### CROSS-REFERENCE TO RELATED APPLICATIONS

None.

### TECHNICAL FIELD

The present disclosure relates generally to high pressure fuel pumps for supplying fuel to internal combustion engines and, more specifically, to high pressure fuel pumps having a tappet roller assembly.

### BACKGROUND

Generally, a tappet roller assembly transmits the rotational force of a combustion engine's cam as an axial force to translate the plunger of a high pressure fuel pump to mechanically drive the pump. In conventional high pressure fuel pumps, the tappet roller assembly has a roller shoe with an arced groove provided to retain a roller. Due to complex dimensional requirements of various parts of the tappet roller assembly, such as the groove shape, the related shape of the roller, and the peripheral shape of the roller shoe, the over-all manufacturing cost of the tappet roller assembly is high. Additionally, temperature and pressure can cause the roller to overheat and skid in the groove.

Thus, there remains a need in the art for an improved tappet roller assembly that can transmitting the rotational force of the cam to the plunger of the pump without one or more of the deficiencies mentioned above.

### SUMMARY OF DISCLOSED EMBODIMENTS

The present disclosure provides a tappet roller assembly in which a roller shoe receives and holds the roller by the shape or contouring of a groove formed within the roller shoe. The present disclosure further provides a tappet roller assembly that is configured to directly lubricate the tappet roller.

In a first aspect, a tappet roller assembly is provided, comprising: a roller shoe having a top surface, a bottom surface, a peripheral surface extending from the top surface to the bottom surface, a roller bore between the top surface and the bottom surface; a roller sized and configured to rotate within the roller bore; and a tappet shell including a peripheral wall and a transverse wall dividing an internal volume of the peripheral wall to form a shoe mounting bore, the shoe mounting bore sized and configured to receive the roller shoe. The roller bore defines an aperture in the bottom surface having a length and a width, and the roller has a diameter greater than the width.

In a second aspect, a tappet roller assembly is provided, comprising: a roller shoe having a top surface, a bottom surface, a peripheral surface extending from the top surface to the bottom surface, a roller bore between the top surface and the bottom surface; a roller sized and configured to rotate within the roller bore; and a tappet shell including a peripheral wall and a transverse wall dividing an internal volume of the peripheral wall to form a shoe mounting bore, the shoe mounting bore sized and configured to receive the roller shoe. A retractor having an external circular portion is located between the transverse wall and the roller shoe, and a central portion of the retractor extends from the external circular portion through the transverse wall.

In some variations of the tappet roller assembly, the transverse wall has an undercut and the external circular portion is located in the undercut.

In some variations of the tappet roller assembly, the transverse wall has an undercut and the external circular portion is located in the undercut.

In a third aspect, a tappet roller assembly is provided, comprising: a roller shoe having a top surface, a bottom surface, a peripheral surface extending from the top surface to the bottom surface, a roller bore between the top surface and the bottom surface, and a lubrication passage extending from the peripheral surface to the roller bore; a roller sized and configured to rotate within the roller bore; and a tappet shell including a peripheral wall and a transverse wall dividing an internal volume of the peripheral wall to form a shoe mounting bore, the shoe mounting bore sized and configured to receive the roller shoe, the peripheral wall including a lubricant supply passage therethrough aligned with the lubrication passage of the roller shoe to enable provision of a lubricant to the roller.

In some embodiments of the tappet roller assembly according to the first, second, or third aspect, the roller bore defines an aperture in the bottom surface, wherein the roller has a cross section along its length larger than the aperture in the bottom surface of the roller shoe.

In some embodiments of the tappet roller assembly according to the first, second, or third aspect, the roller bore has an arcuate surface having an arc greater than 180 degrees.

In some embodiments of the tappet roller assembly according to the first, second, or third aspect, the roller bore defines an aperture in the bottom surface having a length and a width, and wherein the roller has a diameter greater than the width.

In some embodiments of the tappet roller assembly according to the first, second, or third aspect, the lubrication passage comprises an external section and an internal section, the external section having a larger diameter than the internal section, the external section terminating on a surface of the peripheral wall, and the internal section extending from the external section to establish fluid communication with the roller bore.

In some embodiments of the tappet roller assembly according to the first, second, or third aspect, the roller shoe has an inner groove extending from a roller contact surface of the roller bore, and wherein the internal section extends from the external section to the inner grove.

In some embodiments of the tappet roller assembly according to the first, second, or third aspect, the external section is longitudinally aligned and on a common axis with the internal section.

In some embodiments of the tappet roller assembly according to the first, second, or third aspect, the roller shoe comprises a drain passage extending from the top surface to the bottom surface.

In some embodiments of the tappet roller assembly according to the first, second, or third aspect, the roller shoe comprises a drain passage extending from the top surface to the bottom surface, the roller shoe comprises a groove extending from the top surface, and the drain passage extends from the groove to the bottom surface.

In some embodiments of the tappet roller assembly according to the first, second, or third aspect, a retractor having an external circular portion is located between the transverse wall and the roller shoe, and a central portion extends from the external circular portion through the transverse wall.

In some embodiments of the tappet roller assembly according to the first, second, or third aspect, a retractor having an external circular portion is located between the transverse wall and the roller shoe, and a central portion extend from the external circular portion through the transverse wall, wherein the transverse wall has an undercut and the external circular portion is located in the undercut.

In some embodiments, a fuel pump is provided, comprising a tappet roller assembly according to the first, second, or third aspect, and any embodiments thereof.

In some embodiments of the fuel pump, the fuel pump includes a pump housing having a bore; a plunger slidably disposed in the bore and operably coupled to the roller shoe by the retractor; and a cam operable to cause reciprocating movement of the plunger to pressurize fuel.

In some embodiments of the fuel pump, the tappet roller assembly comprises: a roller shoe having a top surface, a bottom surface, a peripheral surface extending from the top surface to the bottom surface, a roller bore between the top surface and the bottom surface, and a lubrication passage extending from the peripheral surface to the roller bore; a roller sized and configured to rotate within the roller bore; and a tappet shell including a peripheral wall and a transverse wall dividing an internal volume of the peripheral wall to form a shoe mounting bore, the shoe mounting bore sized and configured to receive the roller shoe, the peripheral wall including a lubricant supply passage therethrough aligned with the lubrication passage of the roller shoe to enable provision of a lubricant to the roller.

In some embodiments of the fuel pump, the tappet roller assembly comprises: a roller shoe having a top surface, a bottom surface, a peripheral surface extending from the top surface to the bottom surface, a roller bore between the top surface and the bottom surface; a roller sized and configured to rotate within the roller bore; and a tappet shell including a peripheral wall and a transverse wall dividing an internal volume of the peripheral wall to form a shoe mounting bore, the shoe mounting bore sized and configured to receive the roller shoe. The roller bore defines an aperture in the bottom surface having a length and a width, and the roller has a diameter greater than the width.

In some embodiments of the fuel pump, the tappet roller assembly comprises: a roller shoe having a top surface, a bottom surface, a peripheral surface extending from the top surface to the bottom surface, a roller bore between the top surface and the bottom surface; a roller sized and configured to rotate within the roller bore; and a tappet shell including a peripheral wall and a transverse wall dividing an internal volume of the peripheral wall to form a shoe mounting bore, the shoe mounting bore sized and configured to receive the roller shoe. A retractor having an external circular portion is located between the transverse wall and the roller shoe, and a central portion of the retractor extends from the external circular portion through the transverse wall.

In some embodiments of the fuel pump, the roller bore defines an aperture in the bottom surface, wherein the roller has a cross section along its length larger than the aperture in the bottom surface of the roller shoe.

In some embodiments of the fuel pump, the roller bore has an arcuate surface having an arc greater than 180 degrees.

In some embodiments of the fuel pump, the roller bore defines an aperture in the bottom surface having a length and a width, and wherein the roller has a diameter greater than the width.

In some embodiments of the fuel pump, the lubrication passage comprises an external section and an internal section, the external section having a larger diameter than the internal section, the external section terminating on a surface of the peripheral wall, and the internal section extending from the external section to establish fluid communication with the roller bore.

In some embodiments of the fuel pump, the roller shoe has an inner groove extending from a roller contact surface of the roller bore, and wherein the internal section extends from the external section to the inner grove.

In some embodiments of the fuel pump, the external section is longitudinally aligned and on a common axis with the internal section.

In some embodiments of the fuel pump, the roller shoe comprises a drain passage extending from the top surface to the bottom surface.

In some embodiments of the fuel pump, the roller shoe comprises a drain passage extending from the top surface to the bottom surface, the roller shoe comprises a groove extending from the top surface, and the drain passage extends from the groove to the bottom surface.

In some embodiments of the fuel pump, a retractor having an external circular portion is located between the transverse wall and the roller shoe, and a central portion extend from the external circular portion through the transverse wall.

In some embodiments of the fuel pump, a retractor having an external circular portion is located between the transverse wall and the roller shoe, and a central portion extend from the external circular portion through the transverse wall, wherein the transverse wall has an undercut and the external circular portion is located in the undercut.

In some embodiments, a method of manufacturing a fuel pump is provided. The fuel pump may include a tappet roller assembly comprising: a roller shoe having a top surface, a bottom surface, a peripheral surface extending from the top surface to the bottom surface, a roller bore between the top surface and the bottom surface, and a lubrication passage extending from the peripheral surface to the roller bore; a roller sized and configured to rotate within the roller bore; and a tappet shell including a peripheral wall and a transverse wall dividing an internal volume of the peripheral wall to form a shoe mounting bore, the shoe mounting bore sized and configured to receive the roller shoe, the peripheral wall including a lubricant supply passage therethrough aligned with the lubrication passage of the roller shoe to enable provision of a lubricant to the roller. The method may comprise inserting the roller into the roller bore; longitudinally aligning the lubricant supply passage with the lubrication passage; and inserting the roller shoe into the shoe mounting bore of the tappet shell.

In some embodiments of the method, the method comprises, prior to inserting the roller shoe into the shoe mounting bore of the tappet shell, inserting the plunger through the retractor and through the transverse wall, the external circular portion located, after inserting the roller shoe into the shoe mounting bore of the tappet shell, between the transverse wall and the roller shoe.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein;

FIG. 1 is a sectional, side view showing a high pressure fuel pump with a tappet roller assembly according to present disclosure;

FIG. 2 is an exploded view of a tappet roller assembly shown in the pump of FIG. 1;

FIG. 3 is an assembled view of the tappet roller assembly shown in FIG. 2;

FIG. 4 is a perspective view of an embodiment of a roller shoe;

FIG. 5 is a cross-sectional side view of the roller shoe of FIG. 4; and

FIG. 6 is a cross sectional view showing an embodiment of a tappet roller assembly including the roller shoe of FIG. 4.

Although the drawings represent embodiments of the various features and components according to the present disclosure, the drawings are not necessarily to scale and certain features may be exaggerated in order to better illustrate and explain the present disclosure. The same numerals are used to depict the same parts throughout the drawings.

### DETAILED DESCRIPTION

For the purpose of promoting an understanding of the principles of the disclosure, reference will now be made to the embodiments illustrated in the drawings, which are described below and were selected to enable one of ordinary skill in the art to practice the disclosure. No limitation of the scope of the invention is intended by the selection or description of the drawings.

Conventional tappet roller assemblies rely on oil transferred from the cam to tappet roller due to the surface tension of the oil, and from the tappet roller to the roller shoe, for lubrication of the groove in which the tappet roller rotates. However, much of the oil is squeezed out after passing the cam/tappet roller interface. The remaining oil is not sufficient to provide a film of oil on the groove. The problem is exacerbated in high pressure application. This results in excessive wear of the groove and the tappet roller.

The present disclosure provides a tappet roller assembly in which a roller shoe receives and holds the tappet roller by the shape or contouring of a groove formed within the roller shoe. The present disclosure further provides a tappet roller assembly that is configured to directly lubricate the tappet roller. This architecture of the tappet roller assembly allows the high pressure fuel pump to operate at high speed with reduced power drawn from the engine to operate the pump. Furthermore, direct lubrication of the tappet roller results in a light weight architecture and smaller size within the high pressure fuel pump. Additionally, improved lubrication may allow smoother operation of the high pressure fuel pump and lower production and maintenance costs.

Furthermore, in conventional tappet roller assemblies, the spring rests on the transverse wall, or ledge, and when the tappet shoe and body move up, the ledge impacts the spring, causing noise and, over time, debris. Without being bound by theory, it is believed that this form of operation of the plunger causes the plunger to seize.

The present disclosure further provides a tappet roller assembly that is configured to reduce noise and debris by preloading the plunger on the shoe. A retainer is provided which keeps the tappet roller off the camshaft if the plunger seizes.

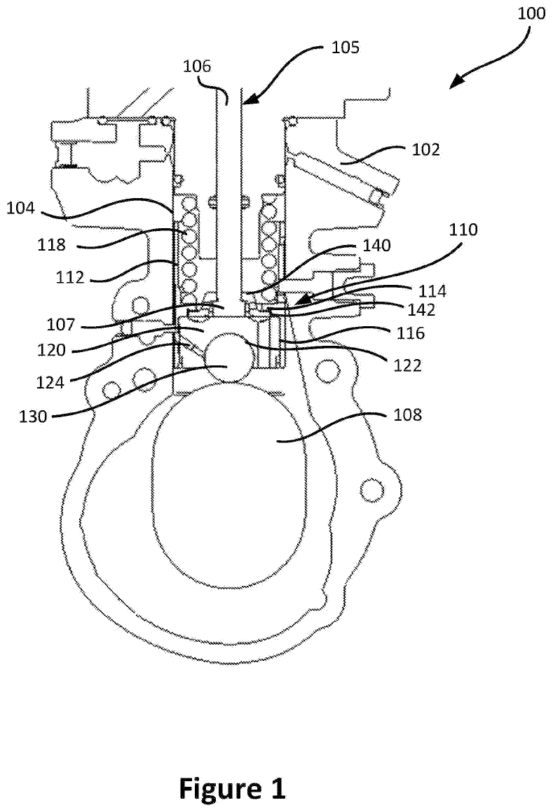

Referring to FIGS. 1-6, a high pressure fuel pump 100 is shown. Pump 100 includes a pump housing 102 that defines a bore 104 and receives a plunger 105 driven by a cam 108 by operation of a tappet roller assembly 110. Plunger 105 comprises a shaft 106 and a foot 107 on its distal end configured to engage a retractor 140 and be operationally connected to a roller shoe 120 thereby. Foot 107 has a larger diameter than shaft 106. Tappet roller assembly 110 includes a tappet shell 112 positioned in bore 104 to reciprocate therein. Tappet shell 112 includes a peripheral wall 113 and a transverse wall 114, on which a spring 118 rests, dividing an internal volume of the peripheral wall to form a shoe mounting bore 116, the shoe mounting bore sized and configured to receive the roller shoe. Transverse wall 114 extends from the inner surface of tappet shell 112 and defines a central opening adapted to receive foot 107 and a central portion of retractor 140. Transverse wall 114 has an undercut 142. Transverse wall 114 retains retractor 140, which also has an external circular portion positioned in undercut 142. The central portion is connected to the external circular portion and extends therefrom away from the roller shoe, such that the central portion extends to one side of the transverse wall and the external circular portion remains on the opposite side of the transverse wall. Optionally, undercut 142 may be omitted. A central portion of retractor 140 traverses the central opening defined by transverse wall 114. Opposite spring 118 is a shoe mounting bore 116 receiving roller shoe 120. Roller shoe 120 has roller bore 122 receiving a roller 130 and having an arcuate roller contact surface in contact (via a film of lubricating fluid) with roller 130. Roller shoe 120 also has a lubrication passage 124 providing a lubricating fluid, or lubricant, to roller 130.

In various embodiments of the high pressure fuel pump described in the preceding paragraph, the arcuate roller contact surface has an arc greater than 180 degrees. In other embodiments of the high pressure fuel pump described in the preceding paragraph, the arcuate roller contact surface has an arc of 180 degrees or less. In all such embodiments, the pressure on the film of lubricating fluid, which is the pressure exerted by the roller on the roller bore, can exceed 2,400 bar. In variations of such embodiments, the arcuate roller contact surface has an average surface roughness of, preferably, less than 0.3 micron, and more preferably, less than 0.2 micron. The following passages provide additional details regarding the arcuate roller contact surface with an arc greater than 180 degrees.

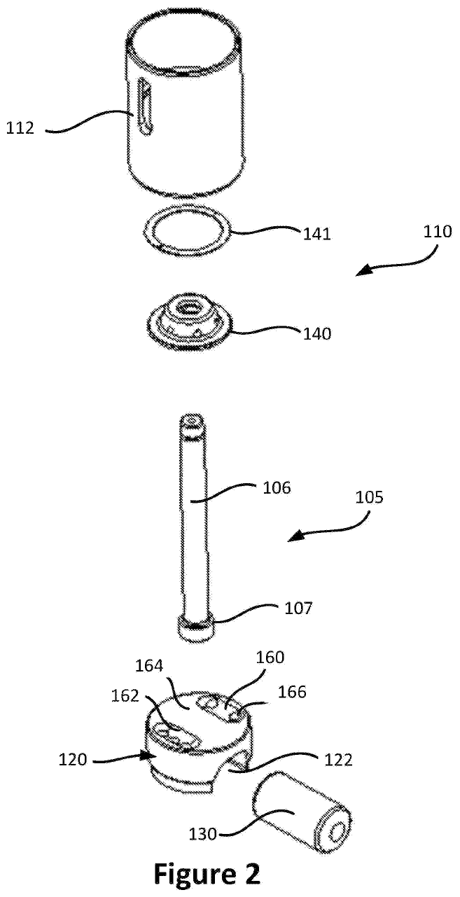

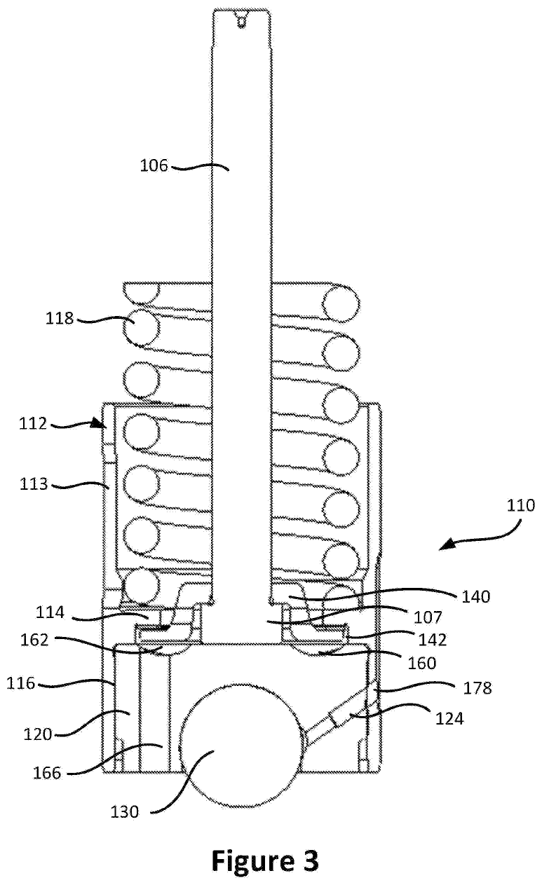

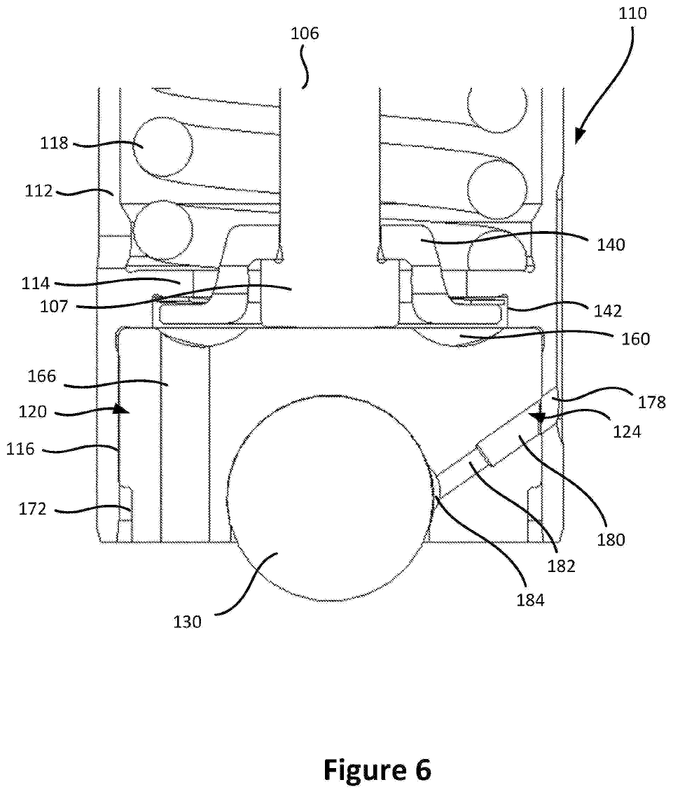

FIG. 2 is an exploded view of the tappet roller assembly shown in FIG. 1. FIG. 3 is an expanded sectional view of the tappet roller assembly shown in FIG. 1. As shown in FIGS. 3 and 6, tappet shell 112 has a lubricant supply passage 178 in fluid communication with lubrication passage 124 of roller shoe 120. FIG. 6 is an even more expanded sectional view of the tappet roller assembly shown in FIGS. 1 and 3, illustrating portions described with reference to FIGS. 2, 4 and 5.

Referring to FIG. 2, tappet roller assembly 110 is assembled by longitudinally sliding tappet roller 130 into roller bore (or groove) 122. Shaft 106 of plunger 105 is inserted through an opening in retractor 140, which has a smaller diameter than the diameter of foot 107, and optionally through a wave washer 141. Retractor 140 is retained by transverse wall 120. Roller shoe 120 is then inserted, optionally press-fit, into shoe mounting bore 116 and retained therein. In some examples, spring 118 has between 800 and 1,000 Newtons of force, more preferably between 850 and 950 Newtons, and even more preferably between 900 Newtons+/−15%. In some variations of the present embodiment, roller shoe 120 has grooves 160, 162 extending from a top surface 164. Drain passages 166 extend through roller shoe 120 from grooves 160, 162 to drain oil from top of tappet roller assembly 110 to cam 108. Two drain passages 166 extend from groove 160, providing space for lubrication passage 124.

In some embodiments, the pressure carried by the lubrication oil film between roller shoe 120 and shoe mounting bore 116 is greater than 2,000 bar, preferably greater than 2,400 bar and even more preferably greater than 2,600 bar, and the average roughness, Ra, of the surface of shoe mounting bore 116 is less than 0.5 micron, preferably less than 0.3 micron, and even more preferably 0.2 micron or less. The fine surface finish ensures that the lubrication oil film, which could be less than 3 micron in thickness, and even less than 2 micron in thickness, is sufficient to prevent direct contact between roller shoe 120 and shoe mounting bore 116. Average roughness is measured by standard measurement methods, such as ASME B46.1. The surfaces may be treated by mechanical polishing, polishing slurries, and/or electropolishing reactions to achieve such fine finish. In one example, the pressure carried by the lubrication oil film between roller shoe 120 and shoe mounting bore 116 is greater than 2,500 bar, and the Ra of the surface of shoe mounting bore 116 is less than 0.25 micron. In another example, the pressure carried by the lubrication oil film between roller shoe 120 and shoe mounting bore 116 is at least 2,600 bar, and the Ra of the surface of shoe mounting bore 116 is less than 0.20 micron.

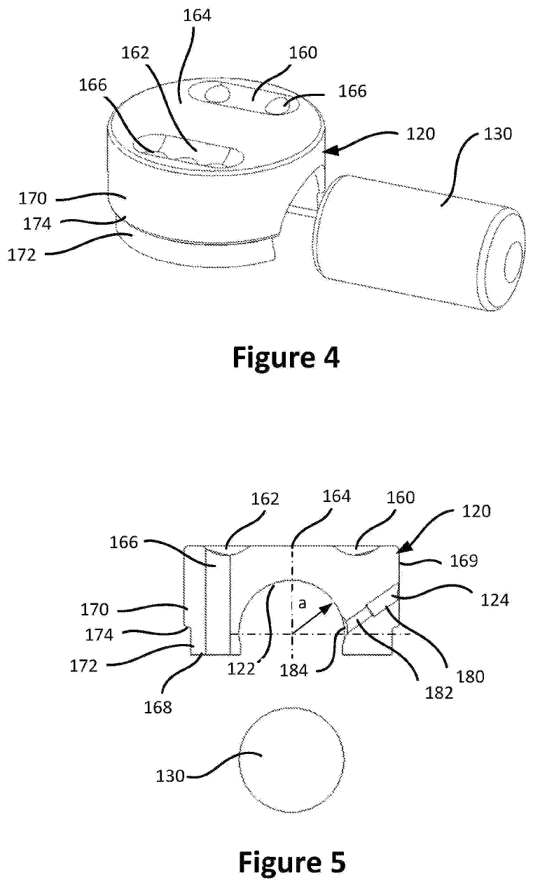

Referring to FIGS. 4 and 5, roller shoe 120 includes roller bore 122 which has a radius “a” and an arc greater than 180 degrees. Accordingly, tappet roller 130, which is cylindrically shaped and has a radius slightly smaller than radius a of roller bore 122, is inserted longitudinally and retained in roller shoe 120 by roller bore 122. The arcuate opening defines an aperture in the bottom surface. The roller has a cross-section along its length larger than the aperture in the bottom surface of the roller shoe, therefore the roller does not pass through the aperture and is retained by the shape of the arcuate opening within the roller shoe.

In some embodiments, roller bore 122 has an arc equal to or less than 180 degrees. The arcuate opening has an arcuate surface in rotatable contact with the roller shoe, i.e. the cylindrical surface of the roller shoe rotates within the space defined by the arcuate surface, and the arcuate surface has an average surface roughness, Ra, preferably less than 0.3 micron, and more preferably less than 0.2 micron.

In some embodiments, roller shoe 120 comprises an upper section 170 with a lower section 172 of smaller diameter than the diameter of upper section 170, with an undercut 174 therebetween. Lower section 172 is suitable for attachment to a tool for manufacturing or assembly.

In some embodiments, lubrication passage 124 comprises an external section 180 having a larger diameter than an internal section 182. Internal section 182 extends from external section 180 at one end and terminates at an inner groove 184 in roller bore 122. The combination of the diameters of sections 180, 182 and inner groove 184 creates a favorable dispersion of oil onto tappet roller 130 to increase lubrication. The diameter of internal section 182 controls the dispersion of oil. An oil reservoir is provided (not shown) which provides oil to lubrication passage 124 even when the engine is not operating, thereby providing initial lubrication during start-up.

The term “oil” is used to simplify the description of the operation of the tappet roller assembly. The tappet roller assembly can operate in a similar manner with any lubricant, including lubricants not generally known as oils.

While the tappet roller assembly is described with reference to a high pressure fuel pump, the advantages presented by the various features described herein are equally applicable to apparatus embodying tappet roller assemblies used under similar operating conditions, regardless whether the apparatus comprise high pressure or pump fuel. Accordingly, the features of the tappet roller assemblies described herein may be applied to low pressure fuel pumps, low pressure pumps in general, and high pressure pumps in general.

Except where a contrary intent is expressly stated, terms are used in their singular form for clarity and are intended to include their plural form.

The terms “comprises,” “including,” “comprising,” “containing,” and “having” and the like have the meaning ascribed to them in U.S. Patent law and denote an open transition meaning that the claim in which the open transition is used is not limited to the components, structures, steps, or the like following the open transition. The terms “consisting of” or “consists of” denote a closed transition meaning that the claim element in which the closed transition is used includes only the components, structures, steps, or the like specifically listed in conjunction with the closed transition.

Occurrences of the phrase “in one embodiment,” or “in one aspect,” herein do not necessarily all refer to the same embodiment or aspect.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

While the embodiments have been described as having exemplary designs, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains.

1. A tappet roller assembly, comprising:
a roller shoe having a top surface, a bottom surface, a peripheral surface extending from the top surface to the bottom surface, a roller bore between the top surface and the bottom surface, and a lubrication passage extending from the peripheral surface to the roller bore:
a roller sized and configured to rotate within the roller bore; and
a tappet shell including a peripheral wall and a transverse wall dividing an internal volume of the peripheral wall to form a shoe mounting bore, the shoe mounting bore sized and configured to receive the roller shoe, the peripheral wall including a lubricant supply passage therethrough aligned with the lubrication passage of the roller shoe to enable provision of a lubricant to the roller.

2. The tappet roller assembly of claim 1, wherein the roller bore defines an aperture in the bottom surface, and wherein the roller has a cross-section along its length larger than the aperture in the bottom surface of the roller shoe.

3. The tappet roller assembly of claim 2, wherein the roller bore has an arcuate surface having an arc greater than 180 degrees.

4. The tappet roller assembly of claim 3, wherein the arcuate surface of the roller bore has an average surface roughness, Ra, less than 0.3 micron.

5. The tappet roller assembly of claim 3, wherein Ra is less than 0.2 micron.

6. The tappet roller assembly of claim 1, wherein the roller bore has an arcuate surface in rotatable contact with the roller shoe, and wherein the arcuate surface has an average surface roughness, Ra, less than 0.3 micron.

7. The tappet roller assembly of claim 6, wherein Ra is less than 0.2 micron.

8. The tappet roller assembly of claim 1, wherein the roller bore defines an aperture in the bottom surface having a length and a width, and wherein the roller has a diameter greater than the width.

9. The tappet roller assembly of claim 1, wherein the lubrication passage comprises an external section and an internal section, the external section having a larger diameter than the internal section, the external section terminating on a surface of the peripheral wall, and the internal section extending from the external section to establish fluid communication with the roller bore.

10. The tappet roller assembly of claim 9, wherein the roller shoe has an inner groove extending from a roller contact surface of the roller bore, and wherein the internal section extends from the external section to the inner grove.

11. The tappet roller assembly of claim 9, wherein the external section is longitudinally aligned and on a common axis with the internal section.

12. The tappet roller assembly of claim 1, wherein the roller shoe comprises a drain passage extending from the top surface to the bottom surface.

13. The tappet, roller assembly of claim 12, wherein the roller shoe comprises a groove extending from the top surface, and wherein the drain passage extends from the groove to the bottom surface.

14. The tappet roller assembly of claim 1, comprising a retractor having an external circular portion located between the transverse wall and the roller shoe, and a central portion extending from the external circular portion through the transverse wall.

15. The tappet roller assembly of claim 14, wherein the transverse wall has an undercut and the external circular portion is located in the undercut.

16. A fuel pump comprising the tappet roller assembly of claim 1.

17. The fuel pump of claim 16, further comprising a pump housing having a bore; a plunger slidably disposed in the bore and operably coupled to the roller shoe by the retractor; and a cam operable to cause reciprocating movement of the plunger to pressurize fuel.

18. A method of manufacturing the fuel pump of claim 1, comprising:
inserting the roller into the roller bore;
longitudinally aligning the lubricant supply passage with the lubrication passage; and
inserting the roller shoe into the shoe mounting bore of the tappet shell.

19. The method of claim 18, comprising, prior to inserting the roller shoe into the shoe mounting bore of the tappet shell, inserting the plunger through the retractor and through the transverse wall, the external circular portion located, after inserting the roller shoe into the shoe mounting bore of the tappet shell, between the transverse wall and the roller shoe.
